(19) United States
(12) Patent Application Publication
(10) Pub. No.: US 2026/0262847 A1
(43) Pub. Date: Sep. 10, 2026

(54) REST ASSEMBLY FOR CHAIRS AND METHOD FOR OPERATING SUCH REST ASSEMBLY

(71) Applicant: Arjo IP Holding Aktiebolag, Malmö (SE)

(72) Inventors: Jon BACKMAN, Malmö (SE); Anders Åbjörnsson, Malmö (SE)

(73) Assignee: Arjo IP Holding Aktiebolag, Malmö (SE)

(21) Appl. No.: 18/881,545

(22) PCT Filed: Nov. 23, 2022
(86) PCT No.: PCT/EP2022/082935

§ 371 Date: Jan. 6, 2025

(30) Foreign Application Priority Data
Jul. 8, 2022 (SE) 2230225-1

(51) Int. Cl. A47C 7/50

(52) U.S. Cl. CPC A47C 7/5066

(57) ABSTRACT

A rest assembly for a chair with a seat portion, the rest assembly comprises a positioning base unit adopted to be arranged to the chair, a rest portion and a supporting member. The positioning base unit comprises an upper part, and a first and second sidewall arranged opposite each other, whereby between the sidewalls a receiving compartment is arranged.

### FIELD OF THE INVENTION

The present invention relates to a rest assembly for chairs, and a chair with a seat portion comprising a rest assembly. The present invention further relates to a method for operating the rest assembly.

### BACKGROUND OF THE INVENTION

Rest assemblies for chairs may be arranged to provide help and support for persons in need of extra support for, for example, legs, head, or arms while being seated in the chair. For example, a patient may position his or her legs in a resting position on a leg rest while being seated on the chair. Reasons to place the legs in resting position on a leg rest may include knee, joint, back, or other problems. A chair with a leg rest assembly may be of good help as it may reduce possible pain, which may have arisen from, for example, back pain. A similar situation, related to rest assemblies arranged for arms or heads, may be when a patient because of the rest assembly can obtain some extra support and comfort while seated on the chair.

Rest assemblies for chairs may have various structures and mechanism depending on how they are arranged and connected with the chair. Commonly, rest assemblies for legs, head, or arms are adjoined to the chair with a mechanism comprising many parts. During patient care, it is common to mount and dismount a rest assembly from the chair if, for example, the rest assembly needs to be cleaned. It is also common for rest assembly to be able to pivotably be adjusted to fit the patients' physical needs while seated in the chair.

An example of a rest assembly with both a mount and release functionality, as well as being able to pivot is presented in US2013181498A1. A drawback with a rest assembly as described in US2013181498A1 is that its pivot mechanism comprises many internal and different parts. All the parts together make operations, mounting, and dismantling of the rest assembly from the chair difficult and time consuming.

### SUMMARY OF THE INVENTION

An object of the present invention is to provide a rest assembly with a pivoting mechanism which is simple in its use and which comprises few internal parts to facilitate operation compared to those of the prior art.

In relation to mentioned object, a further object is to provide a method to operate a rest assembly between a mount and release position, an active position, and a passive position.

The objects are achieved with a rest assembly according to claim 1, a chair with a rest assembly according to claim 17, and a method for operating the rest assembly according claim 18.

The rest assembly for a chair with a seat portion comprises a positioning base unit adopted to be arranged to the chair, a rest portion, and a supporting member. The positioning base unit comprises an upper part, and a first and second sidewall arranged opposite each other, whereby between the sidewalls a receiving compartment is arranged. The support member comprises a first supporting arm, with a first engagement part in which the first supporting arm is arranged with the rest portion. The first engagement part, being in an active position, is pivotably arranged with the receiving compartment in the positioning base unit, and adopted relative to the positioning base unit to alternate the position of the rest portion between the active position, and a mount and release position. The support member comprises a second supporting arm, of which at least one of the supporting arms is resilient, relative to the other supporting arm, to releasably engage with an engagement assembly arranged in the receiving compartment. An effect of the supporting arms being resilient with respect to each other is that it enables the supporting arms to be pressed towards each other. A person may, with his or her hand, grip around the two supporting arms and firmly press the two supporting arms towards each other.

According to one embodiment, the engagement assembly comprises a first and second knob element being arranged on respective sidewalls, and which the respective knob elements project from the respective sidewalls towards each other. The knob element is attached to inside of the sidewall. An effect of the knob element is that it allows cooperating and releasably attaching the knob elements to the supporting arms when the supporting arm is arranged in the receiving compartment. A further effect of the knob element is that when the rest portion is in passive position, the knob element carries part of the weight of the rest portion via the attached supporting arm.

According to one embodiment, the respective side wall facing towards each other, at a lower part of the positioning base unit, a respective first and second shelf element are arranged which project from the respective side wall towards each other. The shelf element is arranged at a periphery region on the lower part on the inside of the sidewall. The shelf element extends away from the inside of the sidewall's surface, facing towards a centre of the positioning base unit. An effect of the shelf part is that it allows receiving and supporting the supporting arm when the rest assembly is in active position. In the active position, the supporting arm is pivotably arranged with the knob element and simultaneously in contact with the shelf element.

According to one embodiment, the receiving compartment comprises a central enforcement element which is arranged with a respective first and second enforcement wall, which face towards the respective side walls, whereby a first space is arranged between the first side wall and the first enforcement wall, and whereby a second space is arranged between the second side wall and the second enforcement wall. The central enforcement element is arranged with the upper and lower part of the positioning base unit. An effect of the central enforcement element is that it creates stability and rigidity of the positioning base unit.

According to one embodiment, the central enforcement element comprises a recess extending between the first and the second enforcement wall. The recess extends between the first and the second space. The recess is formed centrally in the receiving compartment, between the upper and lower part, as well as between first and the second enforcement wall. An effect of the recess is that it reduces stress concentrations in the material of the positioning base unit, which may arise during use. The reduction of stress concentrations further reduces risk of cracks appearing in the material of the positioning base unit.

According to one embodiment, in relation to the first and second space, the central enforcement comprises a respective first and second slot wall, which are arranged at the lower part of the supporting member, which in comparison with the respective enforcement wall, each slot wall is arranged at a distance closer to the respective sidewall. An effect of the respective slot walls is that they prevent the supporting arm to be released and fall out from the receiving compartment when the rest assembly is in active position.

According to one embodiment, the first and second space comprise a respective first and second slot, where the first slot is defined between the first slot wall and the first side wall, and the second slot is defined between the second slot wall and the second side wall, with the respective first and second slot extending from an entrance area of the first and second space towards an inner part of the respective space, and with respective slot arranged parallel to the respective side wall. The respective slots are arranged in the respective first and second space at a lower part and on each side of the central enforcement element. The width of the respective slot is arranged to receive the engagement part of the supporting arm. In direction from the inside surface of the sidewall, towards the centre of the positioning base unit, the combined width of one shelf element, in named direction, together with the width of one slot, is shorter than the length of the knob element extending from the sidewall. An effect of the slots is that they guide the supporting arms between the active position and a passive position. A further effect of the slots is that the slots prohibit the rest portion to move sideways towards one side of the chair.

According to one embodiment, the first and second supporting arm comprise a respective first and second engagement part adopted to engage with the engagement assembly in the first and second space, with resilient movement from at least one of the first and second supporting arms. The supporting arm comprises a metallic material. A second material having plastic characteristics encapsulates a majority of the length of the supporting arm. The first and the second supporting arm are arranged parallel to each other and are connected to, and extend from, a frame arranged in the leg rest assembly. The effect of the first and the second engagement part is that they engage and lock with the engagement assembly.

According to one embodiment, the first and second engagement part each comprise a respective engagement surface, which each comprise a respective hole for engaging with the knob element in the respective first and second space. The hole has a diameter, which is slightly larger than the diameter of the knob element. The first and second supporting arms, when pressed towards each other and moved into engagement position, allow the knob to be fitted and arranged in the hole of the engagement part as the respective support arm will spring towards their original position, upon release of applied pressure. An effect of the hole is that it can receive the knob element and function as a connector between the positioning base unit and the supporting arm.

According to one embodiment, the first and second engagement part each comprise a respective sliding surface which is connected to the respective engagement surface and which is angled with respect to the respective engagement surface towards the other supporting arm. The effect of the angled sliding surface, when the supporting arm enters into engagement position, is that the supporting arm, by the angled sliding surface being in sliding contact with the knob element, will move towards the other supporting arm. If the sliding surface were not angled, its edge would risk colliding with the knob element and thus risk to not being able to enter into engagement position.

According to one embodiment, the respective sliding surface each comprise a rounded edge to adapt to an internal surface of respective first and second space when pivoting movements are applied by the supporting arms relative to the positioning base unit. An effect of the rounded edge is that the knob element may be positioned more centralised on the side wall compared to if the edges were not rounded, which would weaken the structure of the side wall as the knob would have to be placed closer to the periphery of the side wall.

According to one embodiment, the respective engagement surface width over its area, comprising the respective holes, is longer than to the width of the respective supporting arm, at the area where the plastic material ends on the supporting arm. An effect of the increased width over the area comprising the hole, is that the engagement part, comprising the engagement surface, is stronger and more rigid compared to if the area would not have been wider.

According to one embodiment, in a mount and release position, the first and second supporting arm, with their engagement parts, are arranged in the respective first and second space, whereby the first engagement part is arranged to resiliently move between the first side wall and the first enforcement wall, passing by the first slot wall, and whereby the second engagement part is arranged to resiliently move between the second side wall and the second enforcement wall, passing by the second slot wall. An effect of the mount and release position is that in this position the rest portion may be either mounted or released from its engagement with the positioning base unit.

According to one embodiment, in an active position, the first and second supporting arm, with their engagement parts, are arranged at a lower region in regards of the respective side wall, whereby the first engagement part is arranged towards the first side wall, opposite the first slot wall and in a supportive contact with the first shelf element, and whereby the second engagement part is arranged towards the second side wall, opposite the second slot wall and in a supportive contact with the second shelf element (18b). In the active position, the supporting arms are not in a compressed position, the knob elements are placed in the holes of the supporting arms, and the supporting arms are in contact with the shelf elements. An effect of the shelf elements is that they may support, uphold, and maintain the active position of the rest portion. In the active position, the respective slot walls from accidentally being released block the supporting arms.

According to one embodiment, in a passive position, the first and second supporting arm, with their engagement parts are arranged in the respective slot. To enter the passive position, it requires a compressive force to be applied against the first and second supporting arm pressing them towards each other, whereby the distance between the first and the second engagement part is reduced. In the positioning base unit, the slots are parallel to each other. Further, the slots, which are parallel with respect to each other, have a distance between each other, which is shorter than the distance between the oppositely arranged sidewalls. In addition, the slots are arranged to cooperate with the engagement assembly of the respective supporting arm. An effect of the respective slot is that they receive and guide the respective first and second supporting arm in the pivoting movement between the active and the passive position.

According to one embodiment, the rest assembly is a leg rest assembly. An effect of the rest assembly being a leg rest assembly is that the leg rest assembly will be able to provide support to a patient legs while the patient is seated in the chair.

According to one embodiment, the invention further relates to a chair with a seat portion comprising a rest assembly. The rest assembly comprises the features as described and outlined above.

According to one embodiment, the invention also relates to a method of operating the leg rest assembly. More particularly, the method refers to engage a rest assembly between a mount and release position, an active position, and a passive position comprising the steps:
applying a compressive force against at least one of the first and second supporting arm, whereby the respective first and second engagement parts are arranged to move towards each other;
arranging the respective first and second engagement part into the respective first and second space, in the receiving compartment;
releasing the compressive force against the first and second supporting arm, whereby in the respective first and second space, the respective first and second engagement part move away from the respective first and second enforcement wall, towards the respective first and second side wall, the respective first and second sliding surface engage with the respective engagement assembly, arranged in the respective first and second space 20, 21 to the mount and release position;
moving the first and second supporting arm, with the respective engagement part, from the mount and release position, with a pivoting movement, towards being arranged opposite the respective slot walls and in supportive contact with the respective shelf elements to the active position;
applying a compressive force against at least one of the first and second supporting arms whereby their first and second engagement parts move towards the respective slot wall, towards each other, and away from the respective shelf element, with the respective first and second engagement parts being arranged in the first and second slot;
applying a pivoting motion against the first and second supporting arm whereby the first and second supporting arm, with the respective first and second engagement parts, move in the respective first and second slot from the active position to the passive position.

The method enables releasable engagement of the rest portion with the positioning base unit. An effect of the method is that the rest portion may be positioned in the positioning base unit with use of one hand manoeuvre. With the hand manoeuvre, the hand holds around the first and second supporting arms and firmly squeezes the supporting arms towards each other, while simultaneously moving the supporting arms, with its respective engagement parts, into position in the receiving compartment of the positioning base unit.

Upon releasing the rest portion from the positioning base unit, the person grips with the hand around the supporting arms and lifts the rest portion from passive to active position. In the active position, the person firmly squeezes the supporting arms so they move towards each other, pivoting the supporting arms so the engagement parts are moved away from the oppositely arranged slot walls and are arranged in the first and second space. In the respective first and second space, the engagement parts are pressed towards the respective enforcement walls, the respective knob elements will be released from their respective positions in the respective holes of the respective first and second engagement parts. Once the knobs are freed from the holes, the rest portion together with the supporting arms may be separated and moved away from the positioning base unit.

### BRIEF DESCRIPTION OF THE DRAWINGS

The invention is described in more detail below with reference to the appended drawings in which:

FIG. 1 is an overview of a chair with a rest assembly in a mount and release position.

FIG. 2 is an overview view of the chair with the rest assembly in an active position.

FIG. 3 is an overview of a chair with the rest assembly in a passive position.

FIG. 4 is a view from beneath of a positioning base unit together with cross section views A-A, B-B, C-C and D-D.

FIG. 5 is a view from beneath of the positioning base unit, separated from supporting arms arranged with the rest portion.

FIG. 6 is a view from beneath of the supporting arms, entering into an engagement position with the positioning base unit.

FIG. 7 is a view from beneath of the supporting arms, in an active position with the positioning base unit.

FIG. 8 is a view from beneath of the rest assembly, in active position, together with a cross section view A-A.

### DETAILED DESCRIPTION OF PREFERRED EMBODIMENT OF THE INVENTION

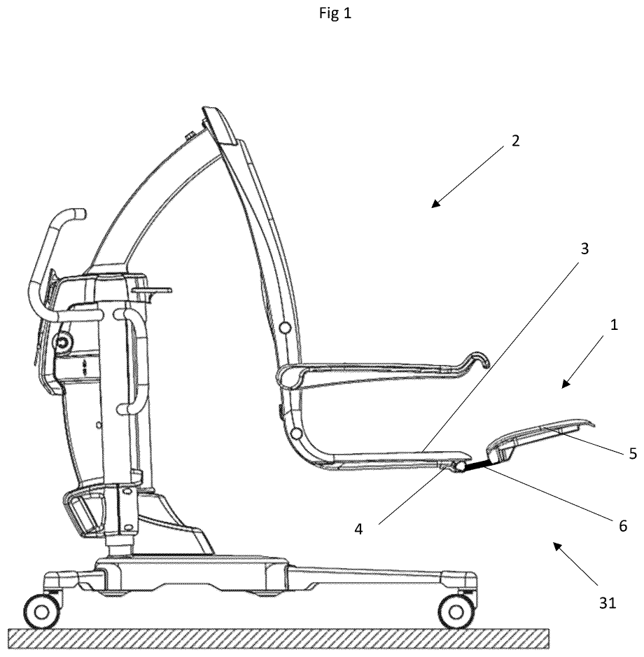

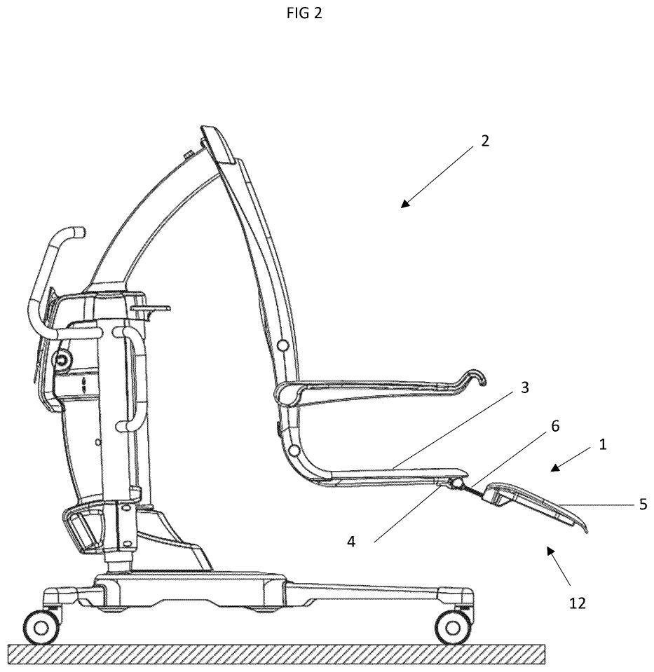

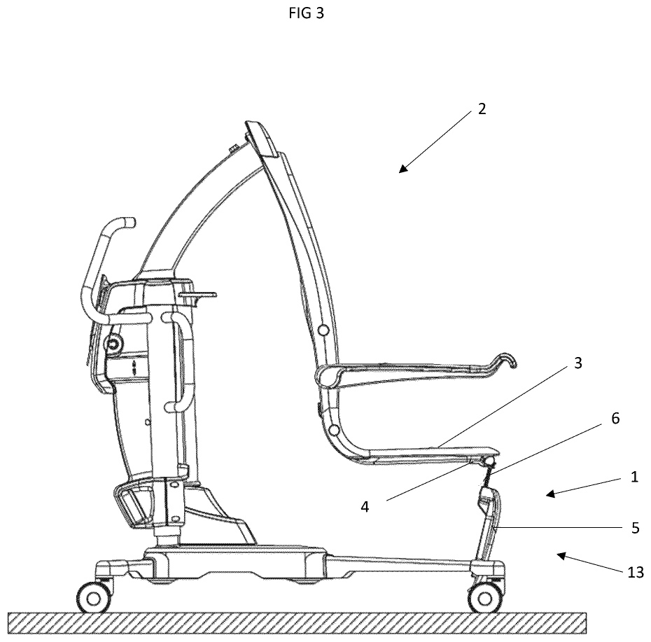

FIGS. 1, 2 and 3 illustrates a chair 2 with a seat portion 3. The chair 2 as illustrated in the figures is arranged with a lifting arrangement as well as with wheels, preferably for seating a patient. The seat portion 3 is arranged with a rest assembly 1. The seat portion 3 comprises a back and a front of which the front in this context is viewed as the part when a person sits on the seat portion 3 and bends his or her lower legs downwards. The rest assembly 1 comprises a positioning base unit 4, a rest portion 5 and a supporting member 6. The supporting member 6 is connected with the rest portion 5. The positioning base unit 4 is arranged on an underside and in the area of the front part of the seat portion 3. The supporting member 6 is releasably arranged with the positioning base unit 4. In engagement position between the positioning base unit 4 and the supporting member 6, the supporting member 6 together with the connected rest portion 5 may be arranged in a mount and release position 31, FIG. 1, an active position 12, FIG. 2, or in a passive position 13, FIG. 3.

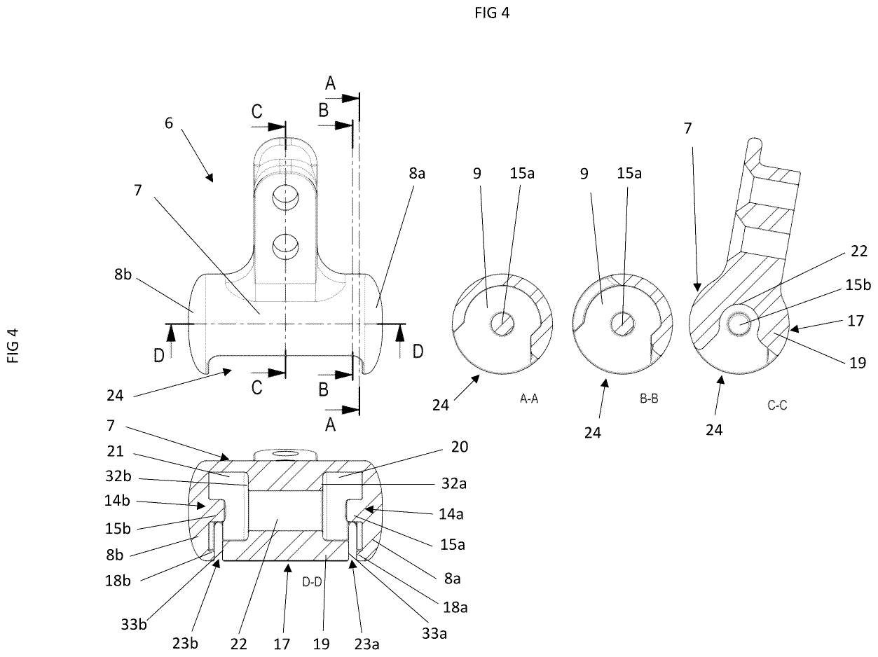

FIG. 4 illustrates the positioning base unit 6 with four cutting plane lines A-A, B-B, C-C and D-D to illustrate the design and the construction of the positioning base unit 6 via the different sections A-A, B-B, C-C and D-D. The positioning base unit 6 comprises an upper part 7, which is arranged to be attached against the underside of the seat portion 3, FIGS. 1 and 2. The positioning base unit 6 further comprises an entrance area 24. The entrance area 24 is an opening, which is arranged between a first and second sidewall 8a, 8b, which are opposite and paralleled arranged with respect to each other. The respective sidewalls 8a, 8b are further arranged between the periphery regions of the upper part 7 and a lower part 17 of the positioning base unit 6. In a position where the positioning base unit 6 and the seat portion 3 are arranged with each other, FIG. 1-3 , the entrance area 24 is arranged to face towards the front of the seat portion 3.

FIG. 4, section A-A and B-B, illustrate the entrance area 24, which is an opening, which leads into a receiving compartment 9.

Referring to FIG. 4, section C-C and D-D, the receiving compartment 9 is defined by the inside opposite arranged sidewalls 8a, 8b, the upper part 7, and the lower part 17 of the positioning base unit 6. The receiving compartment 9 comprises a first space 20, a second space 21 and between the first and second spaces 20, 21, a recess 22 is arranged. The recess 22 is arranged in a central enforcement element 19, connecting the upper part 7 with the lower part 17. The recess 19 is adjoined to a first enforcement wall 32a and second enforcement wall 32b. The first space 20 is defined between the first sidewall 8a and the first enforcement wall 32a. The second space 21 is defined between the second sidewall 8b and the second enforcement wall 32b.

On the inside of the respective first and second side walls 8a, 8b, towards the lower part 17, respective first and second shelf elements 18a, 18b are arranged. The respective shelf elements 18a, 18b are arranged opposite to each other. On the enforcement element's 19 lower part 17, a first and second slot wall 33a, 33b is arranged. Between the first shelf element 18a and the first slot wall 33a, a first slot 23a is arranged. Between the second shelf element 18b and the second slot wall 33b, a second slot 23b is arranged. The respective slots 23a, 23b extend parallel to the respective sidewalls 8a, 8b. The respective slots 23a, 23b further extend from the entrance area 24 towards an inner wall of the respective first and second space 20, 21.

The respective first and second space 20, 21 comprise a respective first and second engagement assembly 14a, 14b. The respective engagement assemblies 14a, 14b comprise a respective first and second knob element 15a, 15b. The respective knob elements 15a, 15b are arranged on the respective insides of the opposite side walls 8a, 8b. The respective knob elements 15a, 15b are arranged to the respective inside side walls 8a, 8b with for example glue, weld, braze, screw, bolt elements, or other method for connecting the knob elements 15a, 15b with the side walls 8a, 8b. Further, the knob elements 15a, 15b may be shaped or manufactured together with the sidewalls 8a, 8b or positioning base unit 4.

The knob elements 15a, 15b, see FIG. 4 D-D, viewed in directed from the inside of the side walls 8a, 8b, have a length which is longer than the combined length, in the same direction, of one shelf element 18a, 18b and one slot 23a, 23b arranged in the space 20, 21.

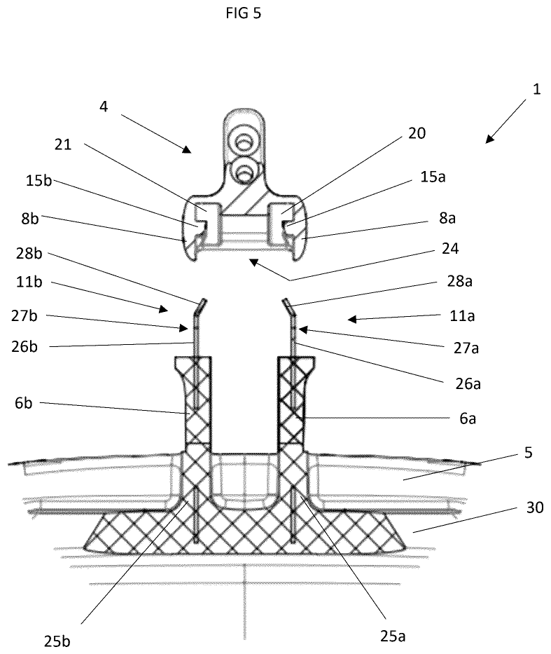

FIG. 5 illustrates the rest assembly 1 in a separated position. In this position, the rest portion 5 may be stored away or, for example, brought to other facility for cleaning.

The rest portion 5 comprises the first supporting arm 6a and the second supporting arm 6b. The first and second supporting arms 6a, 6b are parallel to each other and connected to a frame 30, which is arranged with the rest portion 5. The first and second supporting arms 6a, 6b form one unit together with the rest portion 5. The supporting arms 6a, 6b extend out from one side of the rest portion 5.

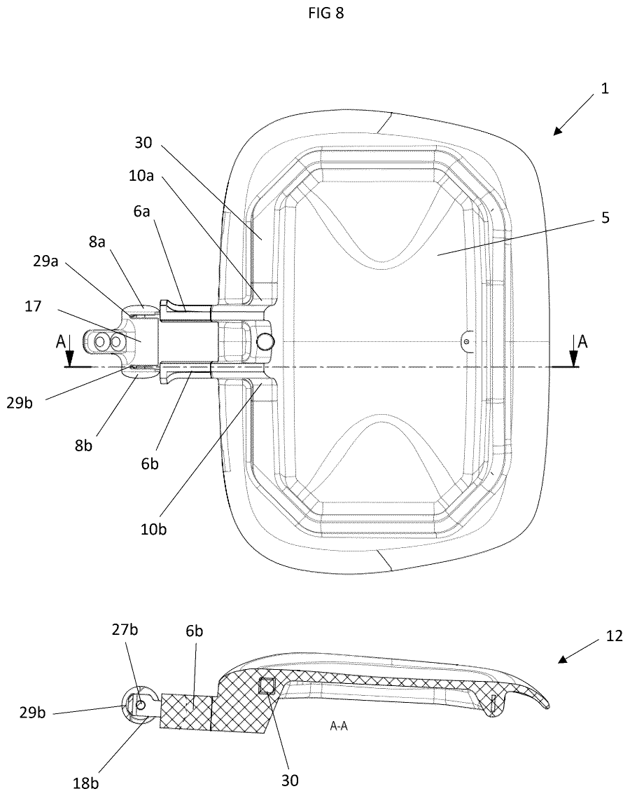

The first and the second supporting arms 6a, 6b comprise a respective first and second end portion 25a, 25b. The respective first and second end portion 25a, 25b are interconnected with the frame 30 of the rest portion 5 via a respective first and second connection area 10a, 10b. Opposite the named end portions 25a, 25b of the respective first and second supporting arms 6a, 6b, and a respective first and second engagement part 11a, 11b is arranged. The first and second engagement parts 11a, 11b each comprise an engagement surface 26a, 26b and a sliding surface 28a, 28b. The respective engagement surfaces 26a, 26b comprise a respective hole 27a, 27b. The respective sliding surfaces 28a, 28b border to the respective engagement surfaces 26a, 26b. The respective sliding surfaces 28a, 28b are angled towards each other with respect to the parallel extension of the respective first and second supporting arms 6a, 6b. The respective sliding surfaces 28a, 28b each comprise a rounded edge 29a, 29b, as shown in FIG. 8, to adapt to an internal surface of respective first and second space 20, 21 when pivoting movements are applied by the supporting arms 6a, 6b relative to the positioning base unit 4.

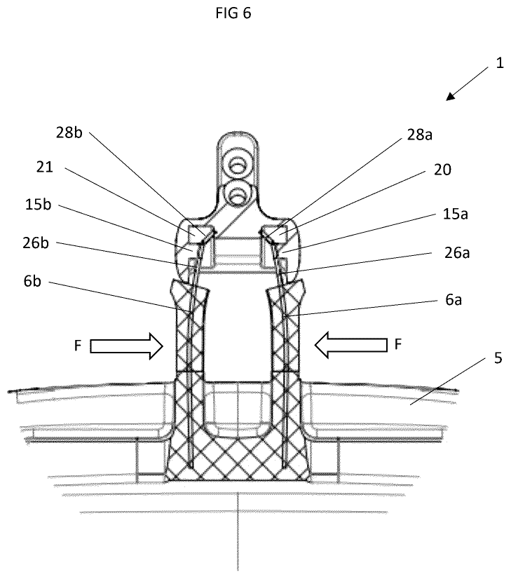

FIG. 6 illustrates a force F applied against the first and second supporting arms 6a, 6b, whereby the supporting arms 6a, 6b with the first and second engagement parts 11a, 11b are arranged to be moved towards each other. The supporting arms 6a, 6b are made of a material with resilient characteristics, whereby the supporting arms 6a, 6b will be able to resiliently return to their original form or position when the force F is ceased. In the movement when the supporting arms 6a, 6b are being pressed towards each other, the supporting arms 6a, 6b may be moved into engagement position with the respective first and second engagement parts 11a, 11b, FIG. 6. When the engagement parts 11a, 11b enter the space 20, 21, the angled sliding surfaces 28a, 28b are arranged to slidably engage with the knob element 15a, 15b in the respective spaces 20, 21. The angled sliding surfaces 28a, 28b contribute, as the engagement parts 11a, 11b are being moved into the respective space 20, 21 and sliding against the knob elements 15a, 15b, the respective supporting arm 6a, 6b are pressed towards each other. The angled sliding surfaces 28a, 28b border the engagement surfaces 26a, 26b, which comprises a hole 27a, 27b arranged to receive the respective knob elements 15a, 15b.

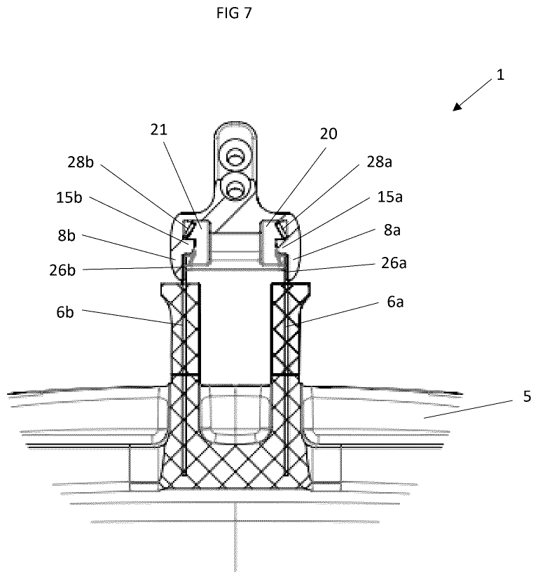

FIG. 7 illustrates the respective engagement parts 11a, 11b positioned into engagement position in the spaces 20, 21, the holes 27a, 27b are arranged to receive the knob elements 15a, 15b, whereby the supporting arms 6a, 6b have resiliently returned back to substantially its original position. In this position, the supporting arms 6a, 6b are connected with the knob elements 15a, 15b, have entered the mount, and release position as shown in FIG. 1. At a second step after the mount and release position, the respective engagement parts 11a, 11b will be pivoted towards the respective shelf elements 18a, 18b and make contact with the respective shelf elements 18a, 18b whereby the rest assembly 1 will be in active position as shown in FIG. 2.

In the situation where the rest assembly 1 shall be on the chair 2 but in a passive position 13, see FIG. 3, the rest assembly 1 may be angled away to facilitate movement for a patient seated in the chair 2. The passive position 13 is obtained by slightly pressing together the supporting arms 6a, 6b, which are in active position 12, as the knob elements 15a, 15 continue to be arranged in the holes 27a, 27b. From the active position 12, the supporting arms 6a, 6b are slightly pressed together, whereby the respective engagement parts 11a, 11b are freed from the shelf elements 18a, 18b and arranged towards the respective first and second slot walls 33a, 33b. In this position, the supporting arms are then slidably arranged in the slots 23a, 23b, arranged to be pivoted in direction away from the entrance area 24, towards a respective end parts of the respective slots 23a, 23b. The respective end parts in the respective slots 23a, 23b are oppositely arranged with respect to the entrance area 24.

To release the supporting arms 6a, 6b, the supporting arms 6a, 6b need to be pivotably moved from their passive position 13 in the respective slots 23a, 23b, to be arranged in the active position 12 as shown in FIG. 2. In the active position 12, a force F is applied on the supporting arms 6a, 6b, allowing the supporting arms 6a, 6b to be pressed towards each other until the respective engagement parts 11a, 11b are stopped from moving further by the respective slot walls 33a, 33b. To proceed with releasing of the supporting arms 6a, 6b, the supporting arms 6a, 6b are to be pivotably moved in a direction away from the respective shelf element 18a, 18b and the respective slot walls 33a, 33b. In the first and second spaces 20, 21, the respective engagement parts 11a, 11b are allowed to be further pressed towards each other and towards the respective enforcement walls 32a, 32b until the respective knob elements 15a, 15b are freed and not arranged in the respective holes 27a, 27b of the respective engagement parts 11a, 11b. In this position, the rest assembly is now in release position 31 whereby the supporting arms 6a, 6b may be separated from the positioning base unit 4.

FIG. 8 illustrates the rest portion 5 underside that comprises a frame 30 extending around the periphery of the rest portion 5 underside. The supporting arms 6a, 6b are arranged with the frame 30 at connection areas 10a, 10b on the frame 30.

FIG. 8, section A-A, illustrates a cross view of the rest portion 5 in an active position 12. In the active position 12, the supporting arms 6a, 6b are arranged in substantial parallel direction with respect to each other, and not pressed together. Further, in the active position 12, the engagement parts 11a, 11b are engaged via their arranged holes 27a, 27b, arranged with the knob elements 15a, 15b and in contact with the shelf elements 18a, 18b. The respective engagement parts' 11a, 11b lower edges are arranged to be in contact on the respective shelf element 18a, 18b. In this position, the supporting arms 6a, 6b, with the rest portion 5, are arranged in a position between substantial horizontal and partly downwards leaning. The active position 12 is a position arranged between the mount and release position 31 and the passive position 13 as shown in FIG. 1-3 .

Hereinbefore it has been described that the rest assembly is to be arranged on a chair, preferably for patients. It will be appreciated that the principles described above may be applied to chairs of other types as well, and to various types of rest assemblies such as leg rest, headrest or arm rest.

### REFERENCE SIGNS

1 rest assembly for i.e. legs
2 chair
3 seat portion
4 positioning base unit
5 rest portion for i.e. legs
6 supporting member
6a first supporting arm
6b second supporting arm
7 upper part
8a first sidewalls
8b second sidewalls
9 receiving compartment
10a first connecting area
10b second connecting area
11a first engagement part
11b second engagement part
12 active position
13 passive position
14a, b engagement assembly
15a first knob element
15b second knob element
16a, b edge projection element
17 lower part
18a first shelf element
18b second shelf element
19 central enforcement element
20 first space
21 second space
22 recess
16
23a first slot
23b second slot
24 entrance area
25a first end portion
25b second end portion
26a, b engagement surface
27a, b hole
28a, b sliding surface
29a, b rounded edge
30 frame
31 mount and release position
32a first enforcement wall
32b second enforcement wall
33a first slot wall
33b second slot wall
F force

1. A rest assembly for a chair with a seat portion, the rest assembly comprises:
a positioning base unit adopted to be arranged to the chair;
a rest portion; and
a supporting member;
wherein the positioning base unit comprises an upper part, and a first and second sidewall arranged opposite each other, whereby between the sidewalls, a receiving compartment is arranged,
wherein the support member comprises a first supporting arm, with a first engagement part in which the first supporting arm is arranged with the rest portion, which first engagement part, being in an active position, is pivotably arranged with the receiving compartment in the positioning base unit, and adopted relative to the positioning base unit to alternate the position of the rest portion between the active position, and a mount and release position, and
wherein the support member comprises a second supporting arm of which at least one of the supporting arms is resilient, relative to the other supporting arm, to releasably engage with an engagement assembly arranged in the receiving compartment.

2. The rest assembly according to claim 1, wherein the engagement assembly comprises a first and second knob element being arranged on respective sidewalls, and which the respective knob elements project from the respective sidewalls towards each other.

3. The rest assembly according to claim 1, wherein on the respective sidewall facing towards each other, at a lower part of the positioning base unit, a respective first and second shelf element, are arranged which project from the respective sidewall and towards each other.

4. The rest assembly according to claim 1, wherein the receiving compartment comprises a central enforcement element which is arranged with a respective first and second enforcement wall, which face towards the respective sidewalls, whereby a first space is arranged between the first sidewall and the first enforcement wall, and whereby a second space is arranged between the second sidewall and the second enforcement wall.

5. The rest assembly according to claim 4, wherein the central enforcement element comprises a recess extending between the first and the second enforcement wall.

6. The rest assembly according to claim 5, wherein in relation to the first and second space, the central enforcement comprises a respective first and second slot wall, which are arranged at the lower part of the supporting member, which in comparison with the respective enforcement wall are arranged at a distance closer to the respective sidewall than the respective enforcement wall.

7. The rest assembly according to claim 4, wherein the first and second space comprise a respective first and second slot, where the first slot is defined between the first slot wall and the first sidewall, and the second slot is defined between the second slot wall and the second sidewall, with the respective first and second slot extending from an entrance area of the first and second space towards an inner part of the respective space, and with respective slot arranged parallel to the respective sidewall.

8. The rest assembly according to claim 1, wherein the first and second supporting arm comprise a respective first and second engagement part adopted to engage with the engagement assembly in the first and second space, with resilient movement from at least one of the first and second supporting arms.

9. The rest assembly according to claim 8, wherein the first and second engagement part each comprise a respective engagement surface, which comprise a respective hole for engaging with the knob element in the respective first and second space.

10. The rest assembly according to claim 9, wherein the first and second engagement part each comprise a respective sliding surface, which is connected to the respective engagement surface and which is angled with respect to the respective engagement surface towards the other supporting arm.

11. The rest assembly according to claim 10, wherein the respective sliding surface each comprise a rounded edge to adapt to an internal surface of respective first and second space when pivoting movements are applied by the supporting arms relative to the positioning base unit.

12. The rest assembly according to claim 9, wherein the respective engagement surface width over its area, comprising the respective holes, is longer than the width of the respective supporting arm, at the area where the plastic material ends on the supporting arm.

13. The rest assembly according to claim 6, wherein, in a mount and release position, the first and second supporting arm , with their engagement parts, are arranged in the respective first and second space, whereby the first engagement part is arranged to resiliently move between the first sidewall and the first enforcement wall, passing by the first slot wall, and whereby the second engagement part is arranged to resiliently move between the second sidewall and the second enforcement wall, passing by the second slot wall.

14. The rest assembly according to claim 6, wherein, in an active position, the first and second supporting arm, with their engagement parts, are arranged at a lower region in regards of the respective sidewall, whereby the first engagement part is arranged towards the first sidewall, opposite the first slot wall and in a supportive contact with the first shelf element and whereby the second engagement part is arranged towards the second sidewall, opposite the second slot wall and in a supportive contact with the second shelf element.

15. The rest assembly according to claim 7, wherein, in a passive position, the first and second supporting arm, with their engagement parts, are arranged in the respective slot.

16. The rest assembly according to claim 1, wherein the rest assembly is a leg rest assembly.

17. A chair with a seat portion comprising the rest assembly according to claim 1.

18. A method to engage the rest assembly according to claim 1 between the mount and release position, the active position, and a passive position, comprising the steps:
applying a compressive force F against at least one of the first and second supporting arm, whereby the respective first and second engagement parts are arranged to move towards each other;
arranging the respective first and second engagement part into the respective first and second space, in the receiving compartment;
releasing the compressive force F against the first and second supporting arm, whereby in the respective first and second space, the respective first and second engagement part move away from the respective first and second enforcement wall, towards the respective first and second side wall, the respective first and second sliding surface engage with the respective engagement assembly, arranged in the respective first and second space to the mount and release position;
moving the first and second supporting arm, with the respective engagement part, from the mount and release position, with a pivoting movement, towards being arranged opposite the respective slot walls and in supportive contact with the respective shelf elements to the active position;
applying a compressive force F against at least one of the first and second supporting arms whereby their first and second engagement parts move towards the respective slot wall, towards each other, and away from the respective shelf element, with the respective first and second engagement parts being arranged in the first and second slot; and
applying a pivoting motion against the first and second supporting arm whereby the first and second supporting arm, with the respective first and second engagement parts, move in the respective first and second slot from the active position to the passive position.
